(19) United States
(12) Patent Application Publication
(10) Pub. No.: US 2019/0123342 A1
(43) Pub. Date: Apr. 25, 2019

(54) Method For Manufacturing An Electrode For A Lithium-Sulfur Battery Using Li2S As An Active Material

(71) Applicants: Commissariat A L'Energie Atomique Et Aux Energies Alternatives, Paris (FR); Centre National De La Recherche Scientifique, Paris Cedex (FR); Universite Grenoble Alpes, Saint-Martin-D'Heres (FR); Institut Polytechnique De Grenoble, Grenoble (FR)

(72) Inventors: Alice Robba, Grenoble (FR); Fannie Alloin, Vizille (FR); Céline Barchasz, Fontaine (FR); Renaud Bouchet, La Tronche (FR); Rémi Vincent, Grenoble (FR)

(21) Appl. No.: 16/129,484

(22) Filed: Sep. 12, 2018

(30) Foreign Application Priority Data
Sep. 15, 2017 (FR) 1758590

(51) Int. Cl. H01M 4/1397; H01M 10/052; H01M 4/62; H01M 4/04; H01M 4/58; H01M 4/136; H01M 4/66

(52) U.S. Cl. CPC H01M 4/1397; H01M 10/052; H01M 4/625; H01M 4/0471; H01M 2004/028; H01M 4/5815; H01M 4/136; H01M 4/663; H01M 4/661; H01M 4/0404

(57) ABSTRACT

The invention relates to a method for preparing a positive electrode for a lithium-sulfur battery, comprising the following steps:
a) a step of preparing a first mixture by placing a carbon additive which is carbon black and/or activated carbon; a carbon organic binder, and a solvent in contact;
b) a step of carbonising said first mixture, by means of which the result is a powder comprising agglomerates of carbon black and/or activated carbon;
c) a step of placing the powder obtained in b) in contact with a powder of Li₂S thus forming a second mixture;
d) a step of melting the powder of Li₂S of the second mixture, by means of which the result is a composite powder comprising agglomerates of carbon black and/or activated carbon and particles of Li₂S;
e) a step of dispersing the powder obtained in d) in an organic binder;
f) a step of depositing the dispersion obtained in e) on a substrate, which is a material comprising carbon fibres or a metal strip; and
g) a step of drying said dispersion thus deposited.

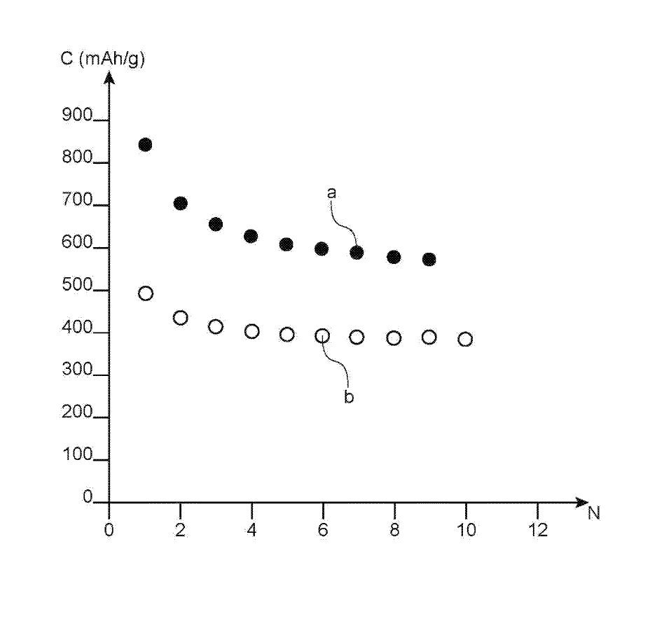

### TECHNICAL FIELD

The present invention relates to a method for manufacturing a positive electrode for a lithium-sulfur electrochemical battery using Li₂S as an active material.

The general field of the invention can thus be defined as that of devices for storing energy, in particular that of lithium electrochemical batteries and, even more particularly, lithium-sulfur electrochemical batteries.

### PRIOR ART

Devices for storing energy are conventionally electrochemical batteries operating on the principle of electrochemical cells suitable for delivering an electric current via the presence, in each of them, of a pair of electrodes (respectively, a positive electrode and a negative electrode) separated by an electrolyte, the electrodes comprising specific materials suitable for reacting according to an oxidation-reduction reaction, by means of which electrons are produced that are responsible for the electric current and there are productions of ions that circulate from one electrode to the other via an electrolyte.

Out of the batteries of this type, the most used currently are the following:
the Ni-MH batteries that use metal hydride and nickel oxyhydroxide as electrode materials;
the Ni—Cd batteries that use cadmium and nickel oxyhydroxide as electrode materials;
the Acid-Lead batteries that use lead and PbO₂ lead oxide as electrode materials; and
lithium batteries, such as lithium-ion batteries, which conventionally use, entirely or partly, lithiated materials as electrode materials.

Since lithium is a particularly light solid element and has a very low electrochemical potential, thus allowing access to an attractive specific energy, lithium batteries have largely deposed the other batteries mentioned above because of the continual improvement in the performance of Li-ion batteries in terms of energy density. Indeed, lithium-ion batteries allow specific energies (which can now reach almost 200 Wh·kg⁻¹) that are clearly greater than those of Ni-MH and Ni—Cd batteries (which can range from 50 and 100 Wh·kg⁻¹) and Acid-lead batteries (which can range from 30 to 35 Wh·kg⁻¹) to be obtained. Moreover, Li-ion batteries can have a nominal cell voltage greater than that of the other batteries (for example, a nominal voltage of approximately 3.6V for a cell implementing the pair LiCoO₂/graphite as electrode materials versus a nominal voltage of approximately 1.5V for the other aforementioned batteries). These systems also have low self-discharge and a high service life (from 500 to 1000 cycles, for example).

Due to their intrinsic properties, Li-ion batteries are therefore of particular interest for the fields in which battery life is a crucial criterion, as is the case of the fields of computers, video, telephony, transport such as electric vehicles, hybrid vehicles, and the medical, spatial, microelectronics fields. However, at present, the technology of lithium-ion batteries is seeing its performance reach its limits.

Currently, a new battery technology based on lithium is appearing as a promising alternative, this technology being lithium/sulfur technology, in which the positive electrode comprises, as the active material, elemental sulfur or a derivative of sulfur, such as lithium sulfide or a lithium polysulfide.

The use of sulfur, as an active material, of a positive electrode is of particular interest since sulfur has a very high theoretic specific capacity that can be up to 10 times greater than that obtained for conventional positive electrode materials (approximately 1675 mAh/g for sulfur instead of 140 mAh/g for LiCoO₂). Moreover, sulfur is present, abundantly, on this planet and is characterised, therefore by low costs. Finally, it is not very toxic. All these qualities contribute to making it particularly attractive for large-scale implementation, in particular for electric vehicles, especially since lithium/sulfur batteries can allow specific energies to be reached that can theoretically reach up to 2600 Wh/kg.

From a functional point of view, the reaction responsible for the production of current (that is to say, when the accumulator is in discharge mode) involves a reaction of oxidation of the lithium at the negative electrode that produces electrons, which supply the outside circuit to which the positive and negative electrode are connected, and a reaction of reduction of the sulfur at the positive electrode.

Thus, explicitly, during the discharge process, the overall reaction is the following:

S₈+16Li→8Li₂S

which is the sum of the reaction of reduction of the sulfur at the positive electrode (S₈+16e⁻→8S²⁻) and the reaction of oxidation of the lithium at the negative electrode (Li→Li⁺₊e⁻).

It is understood that the reverse electrochemical reactions are produced during the charging process.

As is clear from the above equation, the reaction involves an exchange of 16 electrons, which justifies the high specific capacity of the sulfur (1675 mAh·g⁻¹).

From a mechanistic point of view, and without being limited by the theory, in the initial state (that is to say, when the battery is in a completely charged state), the active material, which is elemental sulfur, is present in the solid state in the positive electrode. During the reduction of the sulfur, that is to say, during the discharge, the cyclic molecules of sulfur are reduced and form linear chains of polysulfides of lithium, having the general formula Li₂Sₙ, with n capable of being from 2 to 8. Since the starting molecule is S₈, the first compounds formed are the long-chain lithium polysulfides, such as Li₂S₈ and Li₂S₆. Since these lithium polysulfides are soluble in organic electrolytes, the first discharge step thus involves the solubilisation of the active material in the electrolyte and the production of long-chain lithium polysulfides in solution. Then, as the reduction of the sulfur progresses, the chain length of the polysulfides is gradually reduced and compounds such as Li₂S₈, Li₂S₆ and Li₂S₄ are formed in solution. Finally, the final reduction product is lithium sulfide (Li₂S), which is insoluble in organic electrolytes. Thus, the last step of the mechanism of reduction of the sulfur involves the precipitation of the Li₂S sulfur active material.

However, lithium-sulfur batteries can have a certain number of disadvantages, including in particular poor cycle life. Indeed, during the cycles of charging and discharging, the positive electrode undergoes profound morphological changes induced by the discharge mechanism.

As mentioned above, this mechanism first involves a step of dissolution of the active material, which leads first of all to a collapse of the initial structure of the porous electrode because of the significant percentage of sulfur in the electrode. After dissolution of the sulfur, the porosity of the electrode is such that the structure cannot be maintained and collapses. The electrode available surface area is thus reduced and grains of material or of carbon/binder composite can be detached from the support formed by the current collector. This damage and this resulting loss of active surface area are crucial at the end of discharge, since the species formed, in particular Li₂S, are both very insulating and insoluble in the organic electrolyte. Consequently, they precipitate at the positive electrode and are responsible for its progressive passivation. However, since the thickness of material deposited is limited to several nanometres (Li₂S insulating and thus passivating), the deposition of a significant quantity of active material thus depends on the electrode conductive specific surface area available.

Moreover, the final compound of discharge Li₂S has a volume two times greater than that of sulfur, which can also contribute to the pulverisation of the positive-electrode structure at the end of discharge. In conclusion, the cycles of dissolution/precipitation of the active material inherent to the discharge mechanism are thus partly responsible for the low restored practical capacity and the low cycle life of lithium-sulfur batteries.

Another reason for the poor cycle life can also be the use of metallic lithium as the material forming the negative electrode, since the presence of the metallic lithium can lead to the formation of metal dendrites during the recharging process, which dendrites can cause safety problems.

In order to overcome the latter disadvantage, certain authors have proposed replacing the active material of the positive electrode, which is usually sulfur, with a material that contains sulfur and lithium: Li₂S lithium sulfide. The source of lithium is thus contained in the active material of the positive electrode, which allows the use of metallic lithium at the negative electrode to be eliminated. Moreover, the solubility of Li₂S in ethanol opens the path to new, simple implementations of positive electrodes. This option was in particular explored by Wang et al. (C. Wang, X. Wang, Y. Yang, A. Kushima, J. Chen, Y. Huang and J. Li, Nano. Lett., 2015, 15, 1796-1802) who created positive electrodes for lithium-sulfur batteries comprising nanometric spheres of Li₂S crystallised on sheets of graphene oxide. However, although this type of electrode has good electrochemical performance, this performance is not only due to the intrinsic constitution of the electrode but also to the presence of an additive containing lithium and sulfur in the electrolyte, more specifically, an additive such as Li₂S₈ lithium polysulfide. The presence of this additive allows not only active material to be added to the electrolyte and thus the electrochemical performance to be inflated (in particular, in terms of the restored discharge capacity) but also the activation of the Li₂S during charging and thus its electrochemical activity to be promoted.

The authors of the present invention have thus set out to develop a new method for preparing a positive electrode for a lithium-sulfur battery, which uses Li₂S as an active material and which allows, once operation has begun, the need to use additives such as Li₂S₈ in the electrolyte and also the need to use metallic lithium in order to form the negative electrode to be eliminated.

### DISCLOSURE OF THE INVENTION

Thus, the invention relates to a method for preparing a positive electrode for a lithium-sulfur battery, comprising the following steps:

a) a step of preparing a first mixture by placing a carbon additive which is carbon black and/or activated carbon; a carbon organic binder, and a solvent in contact;

b) a step of carbonising said first mixture, by means of which the result is a powder comprising agglomerates of carbon black and/or activated carbon;

c) a step of placing the powder obtained in b) in contact with a powder of Li₂S thus forming a second mixture;

d) a step of melting the powder of Li₂S of the second mixture, by means of which the result is a composite powder comprising agglomerates of carbon black and/or activated carbon and particles of Li₂S;

e) a step of dispersing the powder obtained in d) in an organic binder;

f) a step of depositing the dispersion obtained in e) on a substrate, which is a material comprising carbon fibres or a metal strip; and

g) a step of drying said dispersion thus deposited.

Thus, the method of the invention comprises, first of all a step of preparing a first mixture by placing a carbon additive which is carbon black and/or activated carbon; a carbon organic binder, and a solvent in contact.

The carbon additive which is carbon black and/or activated carbon is in particular intended to ensure the electrical conduction in the positive electrode.

Examples of carbon black include the carbon blacks sold under the brands Ketjenblack® (AzkoNobel), for example, Ketjenblack® EC-600 JD, Vulcan® (Cabot), Super-P® (Timcal).

With regard to the activated carbon, it is, advantageously, a carbon having a porous structure, consisting of spheroidal particles having a diameter of several micrometres (and more specifically, from 2 to 15 micrometres and even more specifically of approximately 10 micrometres) and comprising pores (specifically from 1 to 100 nm and, even more specifically from 10 to 50 nm) and a large developed specific surface area typically with a specific surface area ranging from 800 to 1800 m²/g.

The carbon organic binders are advantageously polymers having a high concentration of carbon, for example, a concentration of carbon greater than 50% and can be, for example, phenolic resins, which result, conventionally, from the polycondensation of a phenolic monomer and of formaldehyde, as a result of which they are also called phenol-formaldehyde resins or formophenolic resins.

Binders other than phenolic resins may be suitable such as cellulosic binders (such as a carboxymethylcellulose), epoxide binders, polyacetate binders (such as a polyvinyl acetate).

With regard to the solvent, it can be water, an organic solvent, such as an alcoholic solvent or a mixture of organic solvents or a mixture comprising one or more organic solvents and water.

The proportions of these ingredients in the first mixture can be the following:
5 to 50% by weight for the additive which is carbon black and/or activated carbon;
1 to 20% by weight for the carbon organic binder; and
50 to 98% by weight for the solvent;

the weight percentage being expressed with respect to the total weight of the ingredients.

The method of the invention then comprises a step of carbonising the first mixture obtained in step a), which allows the elimination of the carbon organic binder and of the solvent and only leaves carbon from these compounds, for example amorphous carbon, which acts as a cement between the particles of carbon black and/or activated carbon thus forming a powder comprising agglomerates of carbon black and/or activated carbon. Moreover, this step can allow the formation of particles that are exclusively carbon and have a large specific surface area (for example, greater than 1000 m²/g).

The carbonisation step is carried out, advantageously, in an inert atmosphere, for example, in an argon atmosphere, in order to prevent any oxidation phenomena. Moreover, it is carried out, conventionally, at an effective temperature and effective duration necessary for the transformation of the organic compounds into carbon, wherein this temperature and this duration can be easily set by a person skilled in the art by analysing, via conventional techniques, the composition of the product obtained, and the heating can be stopped as soon as only carbon remains in the mixture.

For example, the step of carbonisation can be carried out at a temperature ranging from 800 to 1500° C. for a duration ranging from 1 minute to 10 hours.

In order to accelerate the process of carbonisation, the step of carbonisation as such can be preceded by a step of drying the first mixture obtained in a) in order to at least partly eliminate the solvent followed by a step of grinding the dried material in the form of grains.

After this carbonisation step, there remains a powder consisting of particles resulting from the agglomeration of the carbon black and/or activated carbon bound by amorphous carbon resulting from the carbonisation.

The powder thus formed is then placed in contact, preferably, in an inert atmosphere, with a powder of Li₂S. This powder of Li₂S can be a nanometric or micrometric powder, the particles of which have an average particle diameter of less than 40 μm, wherein such a powder can be available on the market.

The weight ratio between the powder of Li₂S and the powder resulting from the step of carbonisation can be greater than 3 and, for example, can be equal to 3.5.

This step of placing in contact can be accompanied by a concomitant grinding, in which case this step can be carried out in a grinder, for example, a jar mill, which allows an intimate mixture of the ingredients to be obtained, but also a good particle size distribution of the powder to be obtained, in order to simplify the later dispersion.

Between the step of forming the second mixture and the step of dispersion, the method comprises a step involving bringing, preferably in an inert atmosphere, the second mixture to a temperature greater than the melting temperature of Li₂S (for example, a temperature of 1100° C.). Once the melting of the Li₂S is obtained, the temperature is, advantageously, brought back to the ambient temperature. After step d), an intimate mixture (also called composite powder) between the powder of carbon black and/or activated carbon and the particles of Li₂S is thus obtained. Moreover, this heat treatment allows the percolating network of the electrodes obtained to be improved by promoting the Li₂S/carbon contact.

The powder obtained in step d) is then dispersed in an organic binder, which organic binder can be in solution in an organic solvent or an aqueous solvent.

With regard to the organic binder, it can be chosen from:
polymer binders belonging to the category of poly(ethylene oxides) (known by the abbreviation POE);
polymer binders belonging to the category of fluorinated ethylene polymers, such as polytetrafluoroethylene (known by the abbreviation PTFE) and polyvinylidene fluoride (known by the abbreviation PVDF);
polymer binders belonging to the category of vinyl polymers, such as polyvinyl alcohol (known by the abbreviation PVA); and
mixtures thereof.

The organic binder can allow cohesion between the various ingredients of the powder obtained in d), once the positive electrode has been completed.

The organic binder can be present, in the dispersion, in a concentration ranging from 5 to 30% of the total weight of the ingredients of the dispersion (besides the solvent if applicable), an advantageous specific concentration being 10%.

The dispersion thus obtained is then subjected to a step of deposition on a substrate, which can be a material comprising carbon fibres or a metal strip.

More specifically, the material comprising carbon fibres can be a porous material comprising an entanglement of carbon fibres, which material forms an integral part of the positive electrode and allows, via its fibrillar appearance, the mechanical stresses related to its three-dimensional expansion during cycling to be absorbed.

For example, this material can be a nonwoven fabric of carbon fibres.

More specifically, the metal strip can be a strip made of aluminium.

The substrate thus coated is then subjected to a step of drying, in such a way as to eliminate the volatile organic compounds of the dispersion.

The product resulting from the method is a positive electrode for a lithium-sulfur battery and is intended to be assembled in a lithium-sulfur battery comprising at least one cell comprising:
a positive electrode obtained according to the method of the invention as defined above;
a negative electrode; and
an electrolyte that conducts lithium ions, placed between said structure and said negative electrode.

The following definitions are specified.

Positive electrode means, conventionally, above and hereinafter, the electrode that acts as a cathode, when the battery delivers current (that is to say, when it is in the process of discharging) and that acts as an anode when the battery is in the process of charging.

Negative electrode means, conventionally, above and hereinafter, the electrode that acts as an anode, when the battery delivers current (that is to say, when it is in the process of discharging) and that acts as a cathode, when the battery is in the process of charging.

The negative electrode can be self-supporting (that is to say, not requiring placement on a support, such as a current-collector support) or can comprise, preferably, a current-collector substrate on which at least the active material of the negative electrode is placed, this active material not being, advantageously, metallic lithium but, preferably, silicon, graphite, or hard carbon. The absence of metallic lithium for forming the active material of the negative electrode allows a move towards safer batteries.

The current-collector substrate can be made from a metal material (composed of a single metal element or an alloy of a metal element with another element), in the form, for example, of a plate or strip, wherein a specific example of a current-collector substrate can be a strip made of stainless steel, nickel or copper. The current-collector substrate can also be made from a carbon material.

The electrolyte is an electrolyte that conducts lithium ions, wherein this electrolyte can be, in particular, a liquid electrolyte comprising at least one organic solvent and at least one lithium salt.

The organic solvent(s) can be, for example, a solvent comprising one or more ether, nitrile, sulfone and/or carbonate function with, for example, a carbon chain that can comprise from 1 to 10 atoms of carbon.

Examples of solvents comprising a carbonate function include:
cyclic carbonate solvents, such as ethylene carbonate (symbolised by the abbreviation EC), propylene carbonate (symbolised by the abbreviation PC);
linear carbonate solvents, such as diethyl carbonate (symbolised by the abbreviation DEC), dimethyl carbonate (symbolised by the abbreviation DMC), ethylmethyl carbonate (symbolised by the abbreviation EMC).

Examples of solvents comprising an ether function include ether solvents, such as 1,3-dioxolane (symbolised by the abbreviation DIOX), tetrahydrofuran (symbolised by the abbreviation THF), 1,2-dimethoxyethane (symbolised by the abbreviation DME), and an ether having the general formula CH₃O—[CH₂CH₂O]ₙ—OCH₃ (n being an integer ranging from 1 and 10), such as tetraethylene glycol dimethyl ether (symbolised by the abbreviation TEGDME) and the mixtures thereof.

Preferably, the organic solvent is an ether solvent or a mixture of ether solvents.

The lithium salt can be chosen from the group consisting of LiPF₆, LiClO₄, LiBF₄, LiAsF₆, LiI, LiNO₃ LiR_{f}SO₃ (with R_{f} corresponding to a perfluoroalkyl group comprising from 1 to 8 atoms of carbon), LiN(CF₃SO₂)₂ (also called lithium bis[(trifluoromethyl)sulfonyl]imide corresponding to the abbreviation LiTFSI), LiN(C₂F₅SO₂)₂ (also called lithium bis[(perfluoroethyl)sulfonyl]imide corresponding to the abbreviation LiBETI), LiCH₃SO₃, LiB(C₂O₄)₂ (also called lithium bis(oxalato)borate or LiBOB) and the mixtures thereof, the preference being for an LiTFSI/LiNO₃ mixture.

The lithium salt can be present, in the electrolyte, in a concentration ranging from 0.25M to 2M, for example, 1M.

In lithium-sulfur batteries, the aforementioned liquid electrolyte can be brought to impregnate a separator, which is placed between the positive electrode and the negative electrode of the electrochemical cell.

This separator can be made from a porous material, such as a polymer material, suitable for collecting, in its porosity, the liquid electrolyte.

The electrolyte can also be a gelled electrolyte, which corresponds, in this case, to an electrolyte comprising an organic solvent and a lithium salt, similar to those described above, which impregnates a porous matrix that swells when absorbing the electrolyte, wherein such a matrix can be an ethylene polyoxide (known by the abbreviation POE), a polyacrylonitrile (known by the abbreviation PAN), a polymethyl methacrylate (known by the abbreviation PMMA) or a polyvinylidene fluoride (known by the abbreviation PVDF) and their derivatives.

The invention will now be described in reference to the specific embodiments defined below in reference to the appended drawings.

### BRIEF DESCRIPTION OF THE DRAWINGS

The only drawing is a graph illustrating the change in the discharge capacity (in mAh/g) as a function of the number of cycles for two batteries implemented according to the example below.

### DETAILED DISCLOSURE OF SPECIFIC EMBODIMENTS

### Example

The present example illustrates the preparation of a positive electrode according to the method of the invention.

To do this, a first mixture is prepared by placing 400 g of ethanol, Ketjenblack® EC-600 JD carbon black (4 g) and phenolic resin (1 g) in contact. After stirring of the mixture at 4000 revolutions/min for 15 minutes, the ethanol is evaporated in order to obtain a dry material.

The material thus obtained is reduced into grains in order to be carbonised in a tube furnace at 950° C. under argon for 1 hour. This step allows the phenolic resin to be transformed into carbon and the particles of carbon black to be bound together, the resulting material having a large active surface area (greater than 1000 m²/g according to the BET method) and thus being entirely composed of carbon.

The carbon material thus obtained is then mixed with Li₂S for 1 hour in a jar mill, by means of which a homogenous mixture is obtained. The mixture weight ratio between the Li₂S and the carbon is 3.5/1.

The mixture is then subjected to a heat treatment of 1100° C. for 1 hour in an inert atmosphere, which allows the Li₂S to be melted.

The mixture thus obtained after this heat treatment is used for the manufacturing of a liquid composition (or ink) comprising 90% by weight of said mixture and 10% by weight of ethylene polyoxide at 3% in 1,4-dioxane.

The composition thus formulated is then impregnated onto a carbon felt and dried at 40° C. in argon.

For comparison, a reference positive electrode is created using the same carbon felt with a composition comprising:
70% elemental sulfur by weight;
20% Super P® carbon black;
10% ethylene polyoxide;

followed by drying at 80° C. in air.

Two batteries are assembled with, respectively, the positive electrode corresponding to the method of the invention and the reference positive electrode.

Each of these batteries further comprises:
as the negative electrode, an electrode consisting of a strip of metallic lithium;
as the electrolyte, a tetraethylene glycol dimethyl ether/dioxolane (TEGDME/DIOX) mixture (1:1 by volume) comprising LiTFSI (1M) and LiNO₃ (0.1M).

The change in the discharge capacity (in mAh/g) as a function of the number of cycles was determined for these two batteries, the results being reported in the only appended drawing (curve a) for the battery comprising the positive electrode obtained according to the method of the invention and curve b) for the battery comprising the reference positive electrode).

It follows that the battery comprising the positive electrode obtained according to the method of the invention has better performance in terms of discharge capacity than the battery comprising the reference electrode.

What is claimed is:

1. A method for preparing a positive electrode for a lithium-sulfur battery, comprising:
a) preparing a first mixture by placing a carbon additive which is carbon black and/or activated carbon; a carbon organic binder, and a solvent in contact;
b) carbonising said first mixture to prepare a powder comprising agglomerates of carbon black and/or activated carbon;
c) placing the powder obtained in b) in contact with a powder of Li₂S thus forming a second mixture;
d) melting the powder of Li₂S of the second mixture to prepare a composite powder comprising agglomerates of carbon black and/or activated carbon and particles of Li₂S;
e) dispersing the powder obtained in d) in an organic binder;
f) depositing the dispersion obtained in e) on a substrate, which is a material comprising carbon fibres or a metal strip; and
g) drying said dispersion thus deposited.

2. The method of claim 1, wherein the carbon organic binder is a phenolic resin.

3. The method of claim 1, wherein the carbonisation is carried out in an inert atmosphere.

4. The method of claim 1, wherein the carbonisation is preceded by drying the first mixture obtained in a) in order to partly eliminate the solvent followed by grinding the dried material in the form of grains.

5. The method of claim 1, wherein the powder of Li₂S is a nanometric or micrometric powder.

6. The method of claim 1, wherein c) is accompanied by concomitant grinding.

7. The method of claim 1, wherein c) is carried out in an inert atmosphere.

8. The method of claim 1, wherein the material comprising carbon fibres is a nonwoven fabric of carbon fibres.

9. The method of claim 1, wherein the metal strip is a strip made of aluminium.
